(19) United States
(12) Patent Application Publication
(10) Pub. No.: US 2014/0161010 A1
(43) Pub. Date: Jun. 12, 2014

(54) ENABLING HIERARCHICAL WAKEUP SCHEDULES IN A WIRELESS SYSTEM UTILIZING RELAYS

(71) Applicant: QUALCOMM Incorporated, San Diego, CA (US)

(72) Inventors: Simone MERLIN, Solana Beach, CA (US); Amin JAFARIAN, San Diego, CA (US); Bin TIAN, San Diego, CA (US); George CHERIAN, San Diego, CA (US)

(73) Assignee: QUALCOMM Incorporated, San Diego, CA (US)

(21) Appl. No.: 14/103,494

(22) Filed: Dec. 11, 2013

Related U.S. Application Data
(60) Provisional application No. 61/810,667, filed on Apr. 10, 2013.
(60) Provisional application No. 61/736,508, filed on Dec. 12, 2012.

(51) Int. Cl. H04W 52/02; H04B 7/14

(52) U.S. Cl. CPC H04W 52/0235; H04B 7/14
USPC 370/311

(57) ABSTRACT

Certain aspects of the present disclosure provide methods and apparatus for using a hierarchy of wakeup periods for relay devices.

### CROSS-REFERENCE TO RELATED APPLICATIONS

The present patent application claims priority to U.S. Provisional Application No. 61/736,508, filed Dec. 12, 2012, assigned to the assignee of the present application and hereby expressly incorporated by reference in its entirety.

### BACKGROUND

1. Field of the Invention

Certain aspects of the present disclosure generally relate to wireless communications and, more particularly, to enabling hierarchical wakeup schedules in a wireless system utilizing relays.

2. Relevant Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than other IEEE 802.11 groups and has lower obstruction losses.

### SUMMARY

Certain aspects of the present disclosure provide an apparatus for wireless communications. The apparatus typically includes a processing system generally configured to identify a plurality of wakeup periods during which the apparatus may choose to enable radio functions in order to relay data from a first wireless device to a second wireless device, determine, for at least some of the wakeup periods, whether to enable the radio functions based on one or more conditions, and enable the radio functions if the one or more conditions indicate there is data to be received or transmitted.

Certain aspects of the present disclosure provide an apparatus for wireless communications. The apparatus typically includes a processing system generally configured to signal, to one or more stations, a plurality of wakeup periods during which the stations may choose to enable radio functions in order to relay data from a first wireless device to a second wireless device, determine, for at least some of the wakeup periods, whether to enable radio functions based on one or more conditions, and enable radio functions if the one or more conditions indicate there is data to be received or transmitted.

Certain aspects of the present disclosure provide an apparatus for wireless communications. The apparatus typically includes means for identifying a plurality of wakeup periods during which the apparatus may choose to enable radio functions in order to relay data from a first wireless device to a second wireless device, means for determining, for at least some of the wakeup periods, whether to enable the radio functions based on one or more conditions, and means for enabling the radio functions if the one or more conditions indicate there is data to be received or transmitted.

Certain aspects of the present disclosure provide an apparatus for wireless communications. The apparatus typically includes means for signaling, to one or more stations, a plurality of wakeup periods during which the stations may choose to enable radio functions in order to relay data from a first wireless device to a second wireless device, means for determining, for at least some of the wakeup periods, whether to enable radio functions based on one or more conditions, and means for enabling radio functions if the one or more conditions indicate there is data to be received or transmitted.

Certain aspects of the present disclosure provide a method for wireless communications. The method typically includes identifying a plurality of wakeup periods during which the apparatus may choose to enable radio functions in order to relay data from a first wireless device to a second wireless device, determining, for at least some of the wakeup periods, whether to enable the radio functions based on one or more conditions, and enabling the radio functions if the one or more conditions indicate there is data to be received or transmitted.

Certain aspects of the present disclosure provide a method for wireless communications. The method typically includes signaling, to one or more stations, (upcoming occurrence of) a plurality of wakeup periods during which the stations may choose to enable radio functions in order to relay data from a first wireless device to a second wireless device, determining, for at least some of the wakeup periods, whether to enable radio functions based on one or more conditions, and enabling radio functions if the one or more conditions indicate there is data to be received or transmitted.

Certain aspects of the present disclosure provide a computer program product for wireless communications by an apparatus comprising a computer-readable medium having instructions stored thereon. The instructions are generally executable by one or more processors for identifying a plurality of wakeup periods during which the apparatus may choose to enable radio functions in order to relay data from a first wireless device to a second wireless device, determining, for at least some of the wakeup periods, whether to enable the radio functions based on one or more conditions, and enabling the radio functions if the one or more conditions indicate there is data to be received or transmitted.

Certain aspects of the present disclosure provide a computer program product for wireless communications by an apparatus comprising a computer-readable medium having instructions stored thereon. The instructions are generally executable by one or more processors for signaling, to one or more stations, a plurality of wakeup periods during which the stations may choose to enable radio functions in order to relay data from a first wireless device to a second wireless device, determining, for at least some of the wakeup periods, whether to enable radio functions based on one or more conditions, and enabling radio functions if the one or more conditions indicate there is data to be received or transmitted.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example tree structure of a relay system, in accordance with certain aspects of the present disclosure.

FIG. 5 illustrates a block diagram of example operations for wireless communications by a relay, in accordance with certain aspects of the present disclosure.

FIG. 5A illustrates example means capable of performing the operations shown in FIG. 5.

FIG. 6 illustrates a block diagram of example operations for wireless communications by an access point, in accordance with certain aspects of the present disclosure.

FIG. 6A illustrates example means capable of performing the operations shown in FIG. 6.

FIG. 7 illustrates an example use of hierarchical wakeup periods, in accordance with aspects of the present disclosure.

FIG. 8 illustrates an example configuration of wakeup periods, in accordance with aspects of the present disclosure.

FIGS. 9-11 illustrate an example configuration of hierarchical wakeup periods, in accordance with aspects of the present disclosure.

FIGS. 12-14 illustrate example data structures for configuring hierarchical wakeup periods, in accordance with aspects of the present disclosure.

FIGS. 15-30 illustrate example configurations for relayed data exchange using hierarchical wakeup periods in different operating scenarios, in accordance with aspects of the present disclosure.

### DETAILED DESCRIPTION

Aspects of the present disclosure provide enhancements to mechanisms involving certain selective transmission mechanisms, such as target wake-up times (TWTs) and restricted access windows (RAWs). By providing for a ‘hierarchical’ wakeup schedule, certain aspects may allow improvements power consumption by increasing sleep times and may also allow to setup efficient wakeup schedules for multi-hop relays.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

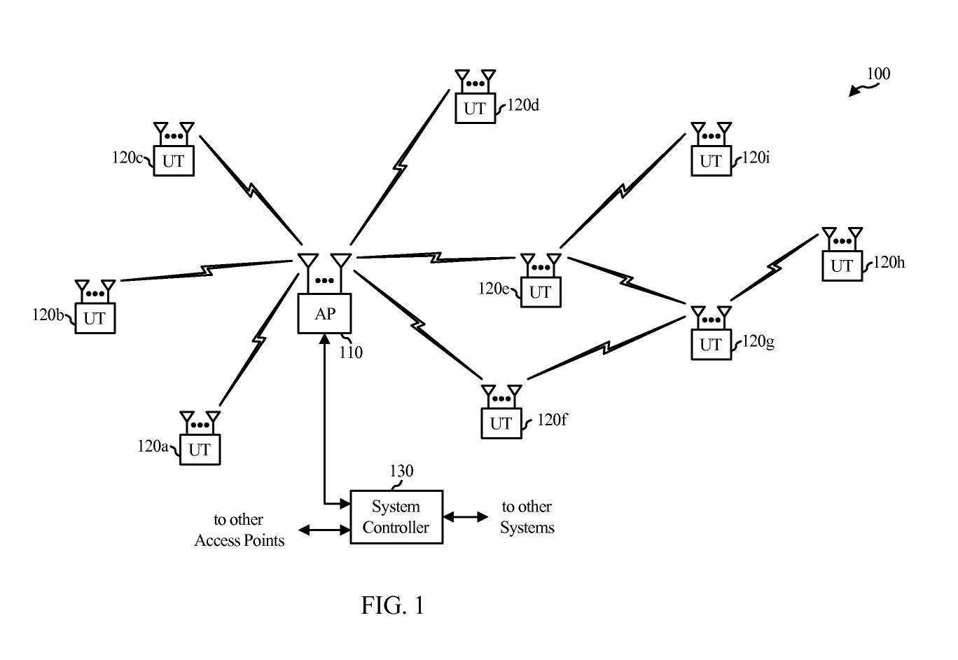

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The SDMA system may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

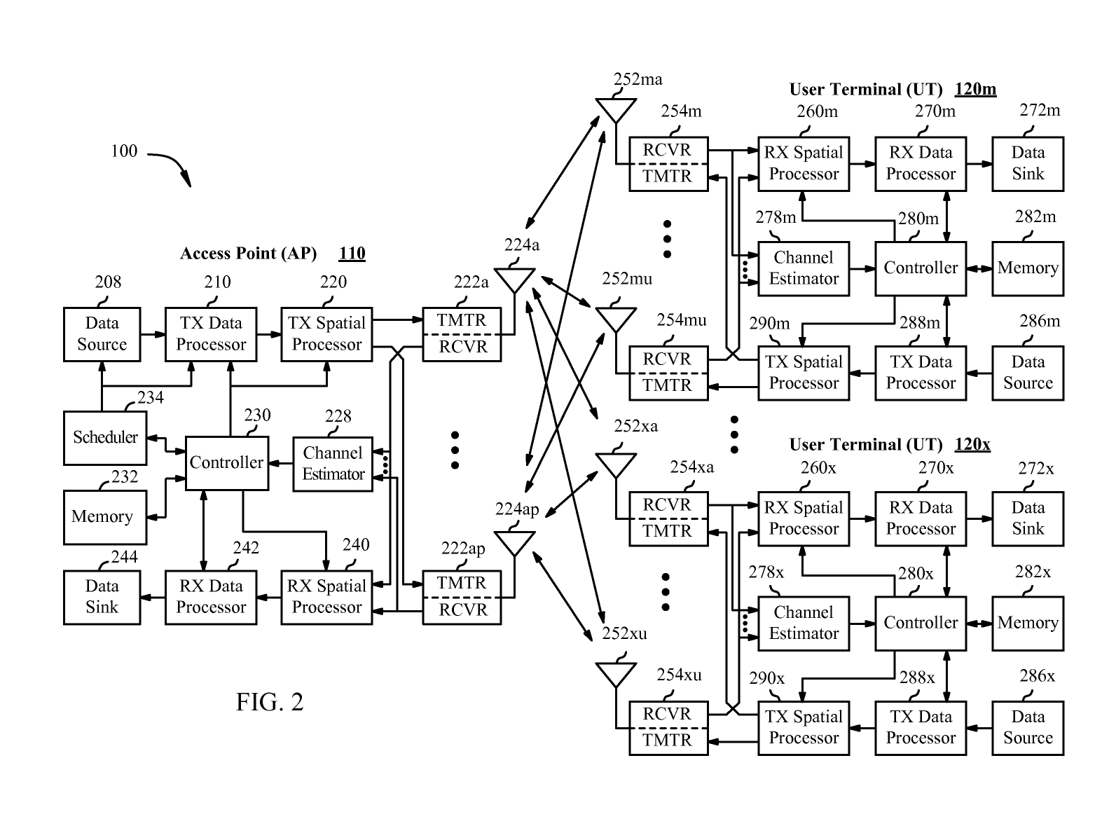

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal

On the uplink, at each user terminal 120 selected for uplink transmission, a transmit (TX) data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

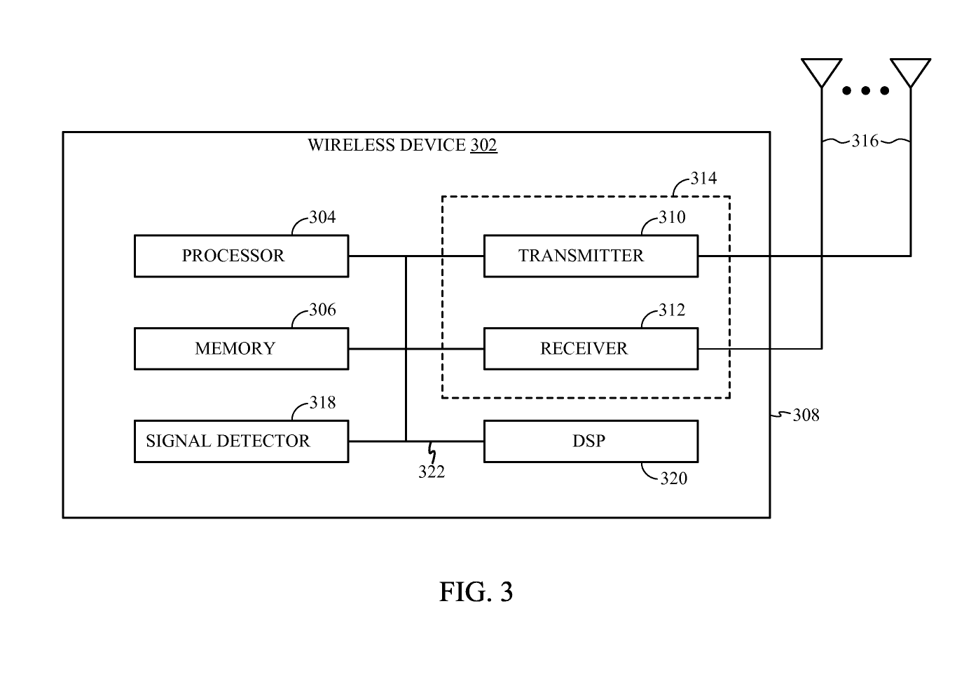

FIG. 3 illustrates various components that may be utilized in a wireless device 302 that may be employed within the MIMO system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Hierarchical Wakeup Schedules in a Wireless System Utilizing Relays

In a relay system utilizing low power devices as relays, it may be desirable to allow relays to enter a low power mode (e.g., sleep with one or more components powered down) whenever possible to reduce power consumption. Further, to keep costs down, it may be desirable to use relays with only limited memory. Thus, a relay may be able to buffer only a small amount of data, and may need to forward the data before being able to receive more.

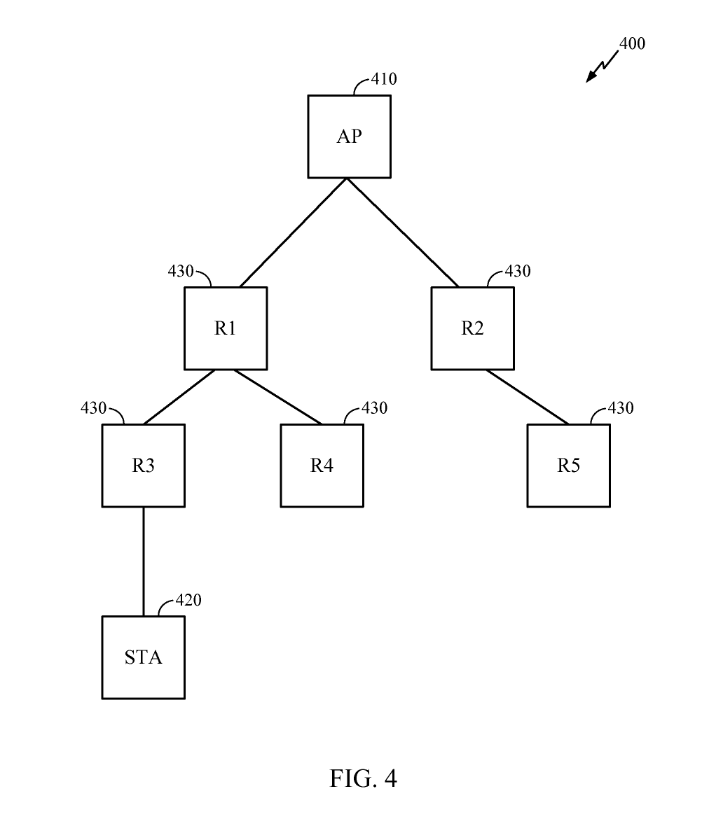

In a multi-hop relay system, such as that shown in FIG. 4, this may present some challenges on how to conserve power—and still ensure devices are awake at appropriate times to relay data. In general, all relays 430 (R1-R5) between an AP 410 and a leaf STA 420 may need to be able to exit a low power state (awaken) quickly, in order to transmit (relay) data in small chunks.

Techniques presented herein may be considered part of a power savings protocol that achieves the above two goals, allowing devices to conserve power and operate with limited amount memory. According to certain aspects, various mechanisms already defined in certain standards (e.g., 802.11 ah), for use in direct communications between an AP and stations, may be modified and extended for use in relay systems.

In various systems, such as IEEE 802.11ah, there may be motivations to utilize relay devices 430 between access points (APs) 410 and stations 420. For example, the use of relays may be desirable because, even with a potential increased downlink (DL) range with 900 MHz (or other “sub-1 GHz) carrier, it may not be sufficient in applications with remote sensors or scenarios with obstructions in AP to STA path. On the uplink, a STA may have substantially lower transmit power than an AP, so the STA may not be able to reach the AP.

Key Characteristics of such systems may include the use of a multi-hop relay using a tree structure, as shown in FIG. 4. A relay-node may be formed by any suitable entity, such as a non-AP-STA (e.g., any station that lacks the ability to act—or is not currently acting—as an AP) that connects to a parent node or an AP-STA that allows association by child nodes. Node-to-node security may be ensured, for example, by the configuration of PSK between each pair of nodes. Relay nodes may support 4-address format with backward learning bridge. In some cases, automatic configuration and re-configuration may be achieved, for example, with a relay node able to attach to a better “parent node.” A relay node may, thus, monitor the health of the link to a parent node.

As will be described in greater detail below, a relay node may also be configured to enter a low power state (e.g., a sleep mode with radio components powered down) in order to conserve battery power. In some cases, a relay node may be configured with scheduled wakeup periods, during which the relay node may transmit and receive data. To conserve power, however, rather than exit the low power state each wakeup period, a relay may decide to exit the low power state only when one or more conditions are met (e.g., when there has been an indication there is data for the relay node to transmit or receive).

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

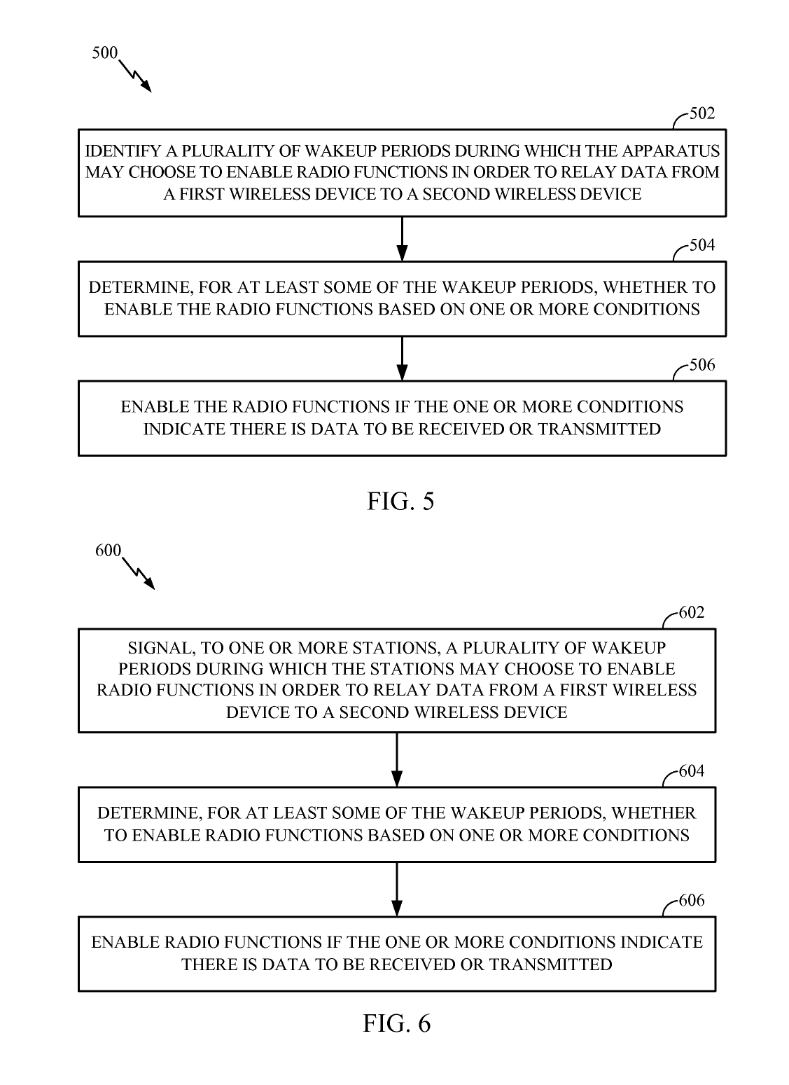

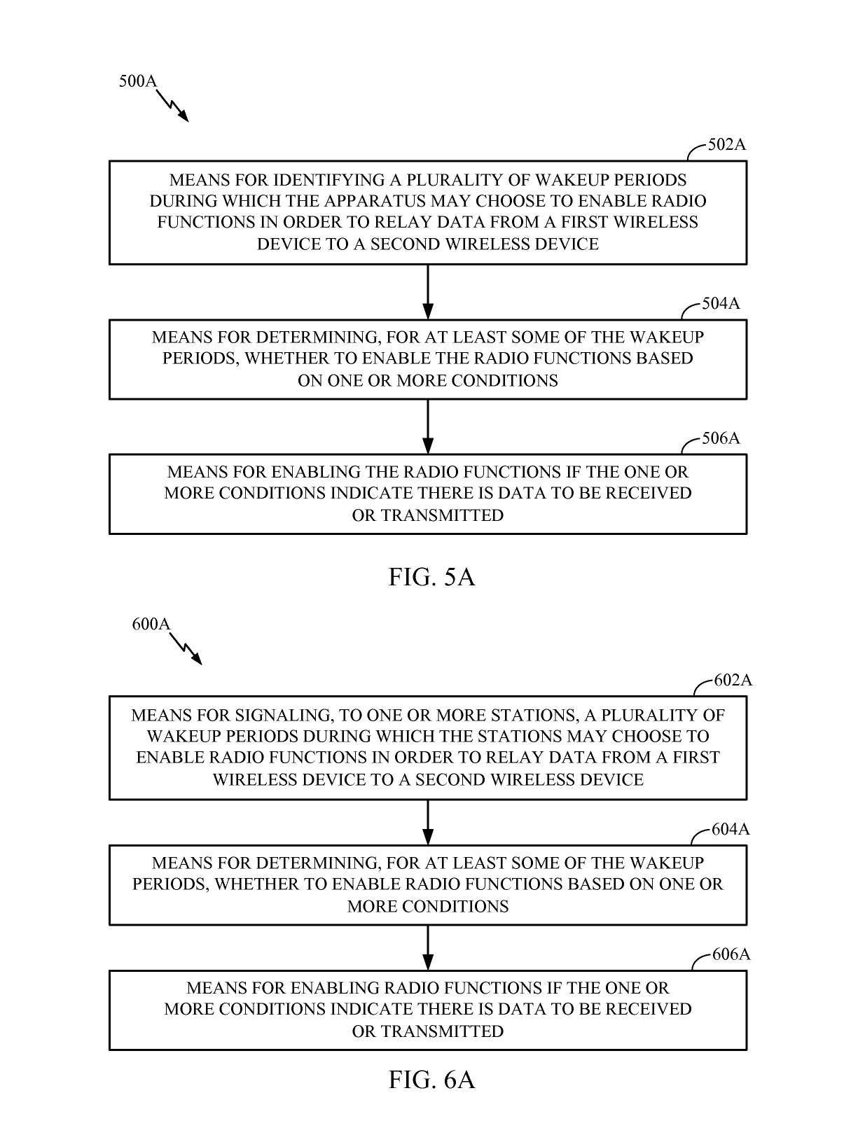

FIG. 5 is a block diagram of example operations 500 for utilizing hierarchical wakeup periods, in accordance with aspects of the present disclosure. The operations 500 may be performed by an apparatus, such as a station, acting as a relay.

At 502, the apparatus identifies a plurality of wakeup periods during which the apparatus may choose to enable radio functions in order to relay data from a first wireless device to a second wireless device. At 504, the apparatus determine, for at least some of the wakeup periods, whether to enable the radio functions based on one or more conditions. At 506, the apparatus enable the radio functions if the one or more conditions indicate there is data to be received or transmitted.

FIG. 6 is a block diagram of example operations 600 for utilizing hierarchical wakeup periods, in accordance with aspects of the present disclosure. The operations 600 may be performed by an apparatus, such as a station, acting as an access point.

At 602, the apparatus signals, to one or more stations, a plurality of wakeup periods during which the stations may choose to enable radio functions in order to relay data from a first wireless device to a second wireless device. At 604, the apparatus determines, for at least some of the wakeup periods, whether to enable radio functions based on one or more conditions. At 606, the apparatus enables radio functions if the one or more conditions indicate there is data to be received or transmitted.

FIG. 7 is an example timing diagram illustrating the general idea of a proposed timing scheme in accordance with aspects of the present disclosure. As illustrated, within a wakeup burst 700, small chunks of data may be sent to a relay, and the relay immediately forwards them. The long sleep may be in the order of multiple seconds (e.g., up to 10 seconds or more). A wake-up burst may be in the order of multi-100 ms (e.g., 500 ms), while each “radio on” period (730, 740 and 750) may be in the order of tens of ms. To conserve power, Relay/STAs may be configured to not wakeup for the wakeup burst if there is no data to be forwarded/received.

The wakeup burst 700 may correspond to any determined wakeup period, such as a configured (periodic) target wakeup time (TWT) or a restricted access window (RAW). For downlink (DL) TWT, a STA1 may ask another AP to agree on a time when STA1 need be awake at least for a minimum amount of time. The AP can use that time to start a transmission to STA1. A Uplink (UL) TWT may operate in a similar manner, but the other way around, with a station using that time to start a transmission to the AP. In some cases, TWTs may occur periodically.

Unfortunately, with conventional TWT configurations, both the STA/AP is awake at each TWT even in the absence of traffic. In the event there is no traffic, this results in a needless waste of power. According to certain aspects, presented herein, however, various rules may be designed to control the use of a TWT. This may allow the definition of an adaptive power saving schedule.

For example, in order to conserve power, rather than exit a low power state with every wakeup period (e.g., TWT), the behavior of a STA/AP at the TWT (or other wakeup period) may be dependent on additional conditions. For example, a TWT may be in effect (meaning the device wakes up) only if additional conditions are fulfilled, otherwise AP/STA can sleep. For example, DL TWT may be in effect only if there is data for the STA, as indicated at a previous time (e.g. in Beacon or ULP or other type message of a previous TWT). Similarly, UL TWT may be in effect only if there is data for the AP from the STA, as indicated at a previous time (e.g. in a Primary TWT as will be described below).

In some cases, 2 types of TWTs may be defined, a Primary type and a Secondary type, with the following rules regarding dependency. In some cases, a STA may be required to be awake at a Primary TWT. For a secondary TWT, on the other hand, the STA/AP may only be required to be awake if a certain event happens at the primary TWT, otherwise STA/AP can sleep at the Secondary TWT. For a DL TWT (for data transmission to a STA), a suitable condition may be that the AP indicated in the Primary TWT that there is Data or More Data for the STA. For an UL TWT, a suitable condition may be that the STA indicated in the primary TWT that it has more UL data to send.

According to certain aspects, the Primary TWT may be defined by periodic wakeups and the Secondary TWTs as “on demand” based on if there are more bufferable units (Bus) of data. The serving STA can send info about the next TWT (potentially using existing frames like BAT, STACK or TACK) in the current TWT, starting from the Primary TWT. As an example, if there are unicast BUs at the AP for STA1, the AP may try to send all of them in the next periodic Primary TWT. However, if that TWT time is insufficient to send all the BUs, the AP may send an indication of the next “on demand” TWT, for example, signaling a station should wake up on the indicated TWT to receive the rest of the packets (this process may be repeated, as necessary, until all packets are sent). At the end, STA1 will know there are no more “on demand” TWTs either implicitly (e.g., the AP will not send the “next TWT” indication anymore) or explicitly (e.g., the AP may send an “end of on demand TWTs” frame to the STA). In either case, the STA can sleep until the next period of the Primary TWT.

According to certain aspects, there may be multiple Secondary TWTs per Primary TWT, for example, with each secondary TWT linked to its primary TWT (e.g., by an identifier). Which Secondary TWT is in effect (meaning a STA will wake up for that TWT), may be based on events happening at the time of the Primary TWT. For example, an AP may indicate there is unicast Data for a STA and use a first (type of) Secondary TWT (e.g., TWT 1), while the AP may indicate there is multicast Data and use a second (type of) Secondary TWT (e.g., TWT 2). According to certain aspects, Primary and Secondary(s) TWT may be defined at once in a single information element (IE). In some cases, the IE may indicate if the period is primary or secondary.

In some cases, the periodic interval of primary and secondary TWTs may be different. Moreover, in some cases, the secondary TWTs may start with an offset with respect to the primary TWT. This may allow propagation of the primary TWT down multiple Relays. If the primary TWT is used to wakeup relay/STAs, this may allow for a wakeup all relays before data is started in the Secondary TWTs. Moreover, to limit the amount of data transferred at each TWT, a STA/AP may indicate a maximum number of Bytes, or MSDUs, or MPDUs, or PPDUs that it will accept at each TWT. As an alternative, the STA/AP may indicate a maximum amount of time it will be awake at each TWT. Secondary TWTs may be in effect, until no more data is available to be transferred (which may be indicated, for example, by More Data=0 in MAC header).

In some cases, according to a first TWT option 1: a transmitter may expect a ‘Poll’ before delivering data. This approach is useful if the receiver STA wants to be in control of its awake cycle (no need for Preferred TWTs) and may be useful if the receiver STA wants to be in control of how much data to receive (e.g., Only 1 MPDU per PS-Poll or Only a max number of MPDUS per Trigger frame). A transmitter (e.g. AP) may then need to wake up at each TWT where a Poll could be received.

According to a second TWT option (e.g., option 2) a transmitter may send data without waiting for a Poll. This approach may have less overhead, but may also require a receiver to be awake at each TWT where there could be data. As an alternative, a transmitter could first send a short data frame with MD=1 just to test if STA is awake. The Transmitter can sleep whenever it does not have data to send.

Assuming TWT option 1 (receiver uses a Poll to poll for data), for TIM (Traffic Indication Map) STAs, referring to STAs that read the beacon to see if an ID there is data for them, it may be expected that TIM STAs read first either a beacon or a ULP which was separately setup. According to the techniques proposed herein, the STA should not send PS-Poll (or trigger frame) unless it knows there are BUs from reading previous Beacon/ULP.

As to when the PS-Poll (or trigger frame) sent, it may be sent immediately after the Beacon/TWT, with contention, if it is assumed that the AP is sleeping, then STA waits for the next TWT. A PS-Poll may also be sent in a RAW for paged STAs or in the next TWT for DL or in the next TWT for UL using a trigger frame.

For non-TIM STAs (STAs that do not read the beacon, and just poll the AP to see if there is data), a “Primary” DL TWT may be defined such that a STA sends PS-Poll (or trigger frame) at a primary TWTs. If ACK to PS-Poll indicates no data, STA goes back to sleep and tries again at the next Primary TWT. Otherwise AP may respond directly with data or indicating that data will be sent and STA can keep using TWTs until Data is over. If no data is indicated, Secondary TWTs need not be in effect.

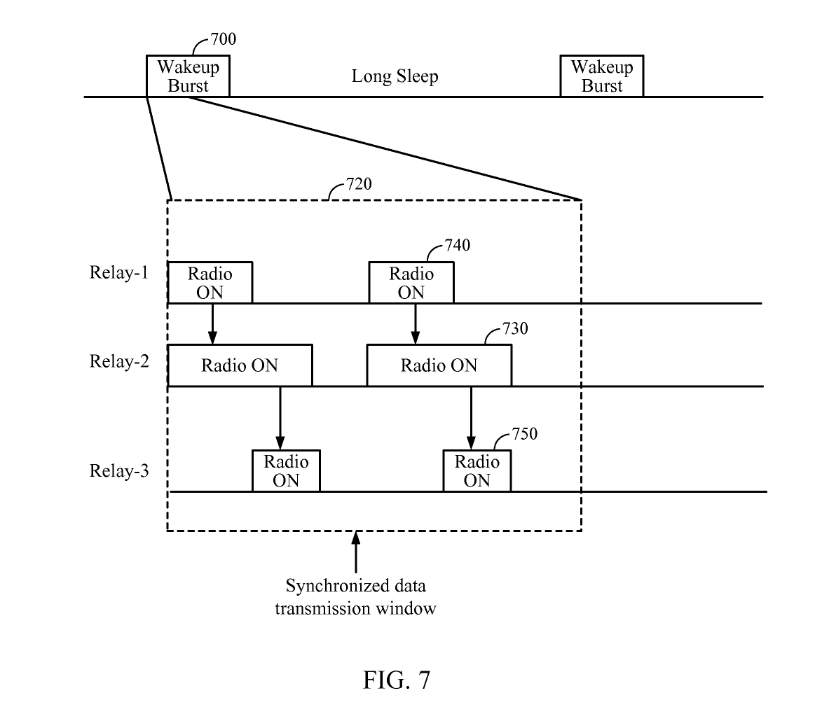

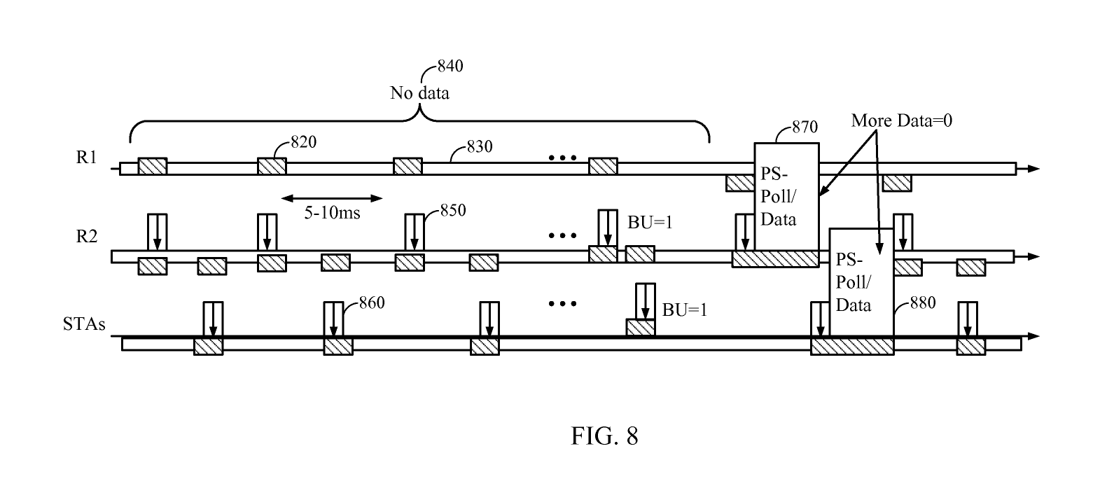

FIG. 8 illustrates an example use of TWTs. As illustrated, an AP may set up frequent TWTs (820, 850, 860) for data delivery to stations (via relays R1 and R2). The TWTs may be spaced apart by a time that allows to send a small amount of data to the relay and allow the relay to forward the data to the next hop. Multiple TWTs may be required to transmit all the necessary data. In this manner, TWTs may be spaced apart, for example, on the order of a few tens of ms, with stations allowed to sleep in periods 830 between TWTs.

The AP may indicate it will be sleeping, except for TWT already declared to each STA. If data transmission is initiated by an AP (e.g., which may be referred to as TWT Option 1), STAs may need be awake at each TWT, in case data is sent. If data transmission is started by a Poll from the STA (.g., which may be referred to as TWT Option 2), the AP may need to be awake at each TWT, in case a PS-Poll is sent.

In the example figure, stations wakeup each TWT regardless of the presence or absence of data. As noted above, however, if there is no data for a long period of time (as depicted by period 840), having devices wake up results in an unnecessary waist of power.

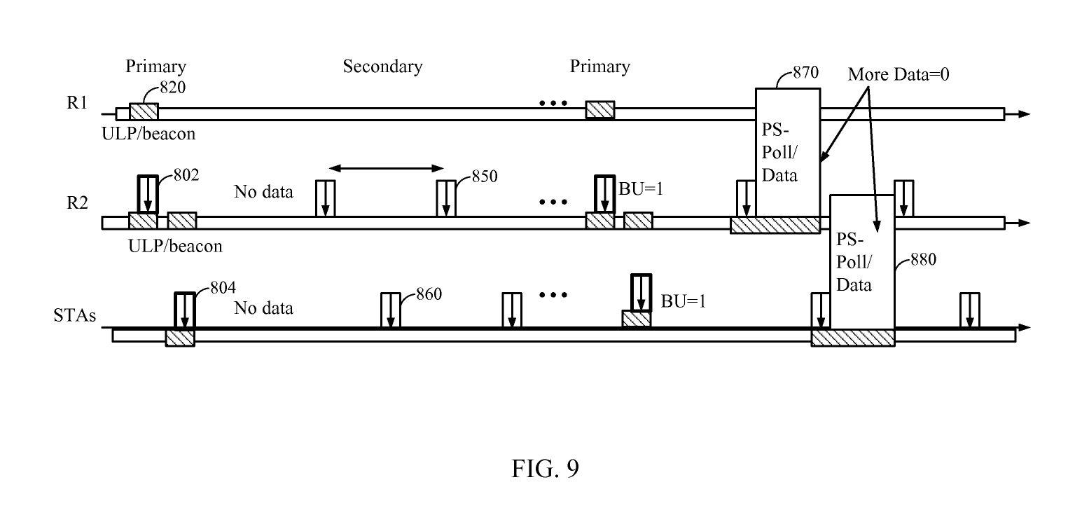

FIG. 9 illustrates an example use of hierarchical TWTs for DL data delivery that may allow for increased sleep intervals, with devices only waking up (820) for certain TWTs. As illustrated, the AP sets up “Primary” TWTs, for example, using a new definition of TWT or by defining an uplink page (ULP) TWT. The AP may also set up (more frequent) TWTs/ROWs for data delivery—but with devices only waking up when there is data. Again, the AP may indicate it will be sleeping, except for RAWs TWT, which are already declared to each STA. According to certain aspects, a standard may indicate that AP may also be sleeping in TWTs if the associated STA(s) are not paged.

As illustrated, a STA wakes up during primary TWTs to monitor for beacons 802 (Beacon/ULP) and see if that STA is paged. If not paged, the STA can go to sleep and consider all following (Secondary) DL TWTs (850 and 860) as canceled. By increasing sleep time, power savings may be achieved, when compared to the example configuration shown in FIG. 8.

On the other hand, if paged, the STA will wakeup at a (Secondary) DL TWTs for DL data delivery and will wakeup at successive TWTs until all data is delivered. In the illustrated example, relay R2 detects that there is DL data to receive (a bufferable unit, as indicated by BU=1) during a primary TWT. Therefore, it wakes up during a secondary TWT to send a PS Poll and receive DL data at 870. Similarly, relay R2 indicates the presence of DL data to STAs during the primary TWT (BU=1), so it may relay the data it receives at 870 to the station in a secondary TWT (at 880).

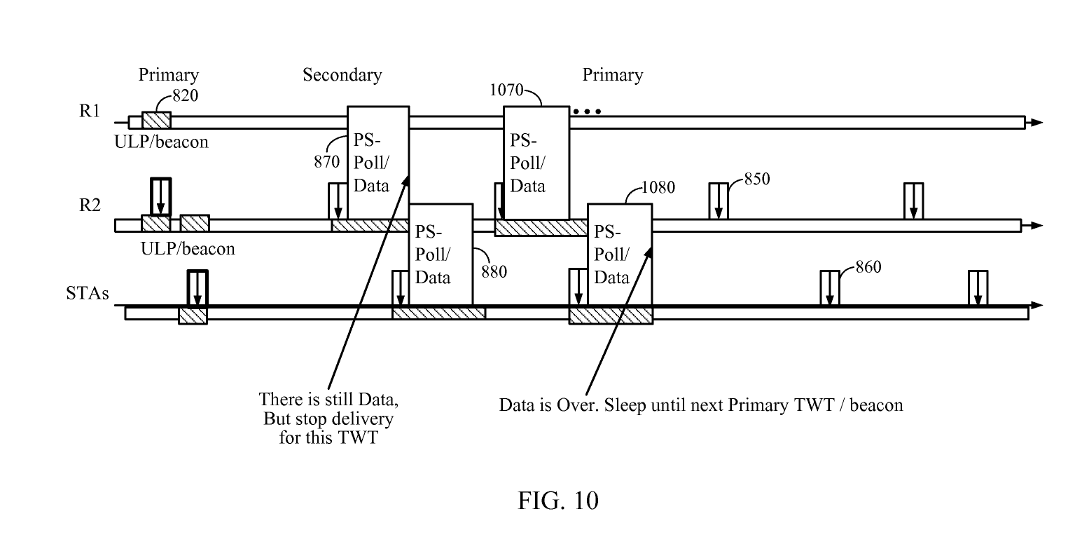

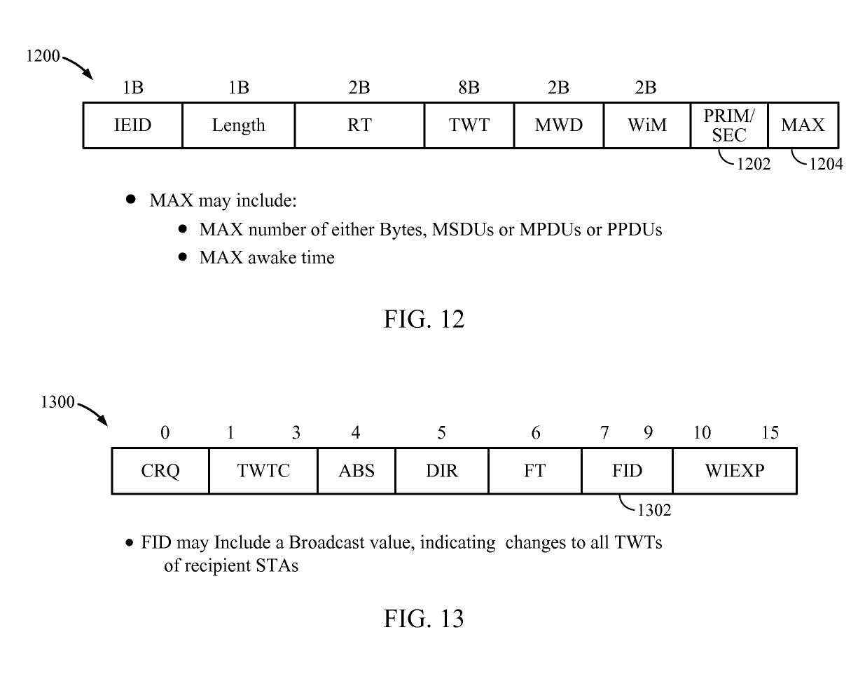

As illustrated in FIG. 10, in some cases, there may be a mechanism to limit the amount of data transferred at each TWT (to limit the buffering and memory requirements) and to end the current wakeup burst (data is over). Such a mechanism is illustrated in FIG. 10, wherein after a first exchange of DL data during a secondary TWT (at 870 and 880) there is still data to deliver, but delivery is halted for that current TWT. Remaining data is finally completely delivered in a later TFT, at 1070 and 1080, such that a device may then sleep until a next primary TWT/beacon. The end of data transfer at each TWT may be indicated, for example, by the transmitter by using the End Of Service Period bit in the MAC Header. As will be described in greater detail below with reference to FIG. 12, the maximum number of data units to be transmitted may be indicated by the receiver at the moment of setting up the Power save mode.

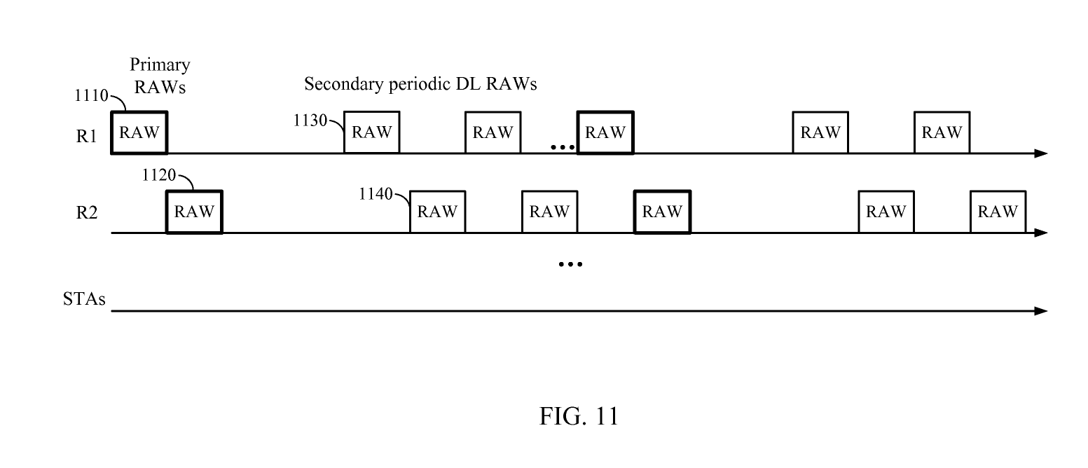

As illustrated in FIG. 11, similar techniques as described above with reference to TWTs may also be applied to restricted access windows (RAWs). 802.11ah specifications define the concept of a RAW, where only a certain subset of STAs is allowed to contend. Moreover, a RAW may be further divided in slots and slots may be assigned to different STAs.

Thus, the behavior of STA/AP at a RAW slot may also dependent on additional conditions. For example, RAW (slot) may be in effect only if some conditions are fulfilled, otherwise AP/STA can sleep. DL Slot may be in effect only if there is data for the STA, as indicated at a previous time (e.g. via receipt of a Beacon or ULP). UL Slot may be in effect only if there is data for the AP from the STA, as indicated at a previous time (e.g. in a Primary TWT/RAW).

As with hierarchical TWTs, 2 types of RAWs may also be defined, a Primary type (such as Primary RAWs 1110 and 1120) and a Secondary type (such as Secondary RAWs 1130 and 1140), with similar rules as described above. For example, a STA may be required to be awake at a Primary RAW, while secondary RAWs (or RAW slots) may be in effect only if a certain event happens at the primary RAW or TWT, otherwise a STA/AP can sleep at the Secondary RAW (slot).

A suitable condition for a DL RAW may be that an AP has indicated in the Primary RAW/TWT that there is Data or More Data for the STA. A suitable condition for an UL RAW may be that a STA has indicated in the primary RAW/TWT that it has more UL data to send. There may be multiple Secondary RAWs per each Primary RAW/TWT, for example, with each secondary RAW linked to a Primary RAW (e.g., by an identifier). Which Secondary RAW is in effect at any given time may be based on events happening at the time of the Primary RAW/TWT. For example, an AP may indicate there is unicast Data for a STA (in a Primary RAW/TWT) and use a first Secondary RAW/TFT 1 to deliver the unicast data. The same AP may indicate there is multicast Data (in a Primary RAW/TWT) and use a second Secondary RAW/TWT 2 to deliver the multicast data. Primary and Secondary(s) RAWs can be defined at once in a single Information element.

The periodic interval of primary and secondary RAWs may be different. Moreover the secondary RAWs may start with an offset with respect to the primary RAW. This may allow propagation of the primary RAW down multiple Relays. If the primary RAW is used to wakeup relay/STAs, this allows to wakeup all relays before data is started in the Secondary RAWs. Moreover, to limit the amount of data transferred at each RAW, STA may indicate a maximum number of Bytes, or MSDUs, or MPDUs, or PPDUs that it will accept at each RAW. As an alternative, an AP may indicate a maximum amount of time it will be awake at each RAW. Secondary RAWs may be in effect, until no more data is available to be transferred (which may be indicated by More Data=0 in MAC header).

As illustrated in FIG. 11, AP sets up regular RAWs for data delivery. The AP may also indicate that some of those RAWs are “Primary.” The AP should keep these RAW small, only for short frames. The AP may indicate that it will be sleeping, except for RAWs/TWTs already declared to each STA. Further, a standard may indicate that the AP may be sleeping in RAWs if the associated STA(s) did not send anything at a primary RAW and did not indicate it has More Data to send. An AP/STA may only awake at the primary RAW, and may be awake at secondary RAWs only if there is data to be exchanged.

For UL Improvements, a Primary and a Secondary RAW. The Primary RAW may use an existing definition, while the Secondary RAW may use an existing definition with further restriction in its use (no new signaling, just rules). As already possible primary RAW may be restricted for indication of UL Paging only, Secondary RAW may be for data. According to certain aspects, STAs may be required to not send data on a secondary RAW, unless they sent a UDI on the primary RAW and AP acknowledges them. An AP may sleep also during that RAW.

For DL improvements, a Primary and secondary TWT/RAW may also be defined. The Primary TWT may use an existing definition, while the Secondary TWT/RAW may be based on a similar definition with further restrictions (no new signaling, just rules). In primary TWT, STA either sends PS-Poll or is awake to receive the first data packet or is a ULP TWT. According to certain aspects, a STA may be required to not send PS-Poll in Secondary (‘PS-Poll TWT’) unless in a primary TWT it already received an ACK to either a PS-Poll or a Data packet with MD=1 or received a ULP with BU=1. According to certain aspects, the AP may be required to not send PPDUs for a STA in a secondary TWT, unless the STA sent a PS-Poll following a primary TWT (may make an exception if ULP is used and don't want STAs to send PS-Poll).

Hierarchical wakeup period configurations may be signaled in any suitable manner. For example, hierarchical TFTs may be signaled via a data structure such as that show in FIG. 12. In FIG. 12, the various fields are illustrated, RT (Request Type) may indicate a Suggestion, Demand, AP accepts, offers alternative for TWT, may be a Relative vs Absolute TSF reference, Exponent for WiM, Flow Direction bit, Flow ID, Flow Type (Request vs NoReq). TWT (Target Wake Time) may relate to TSF (i.e. units are usec, 64 bits) and may be an ABSOLUTE or RELATIVE value, depending on RT indication. MWD (Minimum Wake Duration) may indicate a minimum time (×32 usec) which a device should stay awake to monitor for activity, while WiM (Wake Interval Mantissa) may be required wake interval for indicated direction. This information may be exchanged during Association (always initiated by client), can also be sent in MGMT Action frame to update during association. A device may also send more than one IE (e.g. one for each direction, and may accommodate multiple phases and periods), and may not be restricted to use by Z-class STA.

According to certain aspects, various fields may be added to the fields shown in FIG. 12. For example a field 1202 indicating whether the IE is for a Primary or Secondary TFT may be added. In addition, a mechanism may be added that limits an amount of data per TFT, for example, by providing a field 1204 that specifies a maximum allowable number of either Bytes, MSDUs or MPDUs or PPDUs or a MAX awake time. In addition, such a mechanism may include the identifier of the related Primary TWT.

FIG. 13 illustrates an example RT field. As illustrated, the RT field may include a plurality of fields/sub-fields, such as a CRQ (Client Request) indicating an AP response or client request, a TWTC (TWT Command), ABS (Absolute), DIR (Flow Direction), FT (Flow Type), and a FID (Flow ID) 1302. In some cases, the FID 1302 may include a Broadcast value, for example, indicating changes to all TWTs of recipient STAs. The RT field may also include a field for a Wake Interval Exponent (WIEXP) used to determine a wake interval (e.g., Wi=WiM×2̂WiEXP).

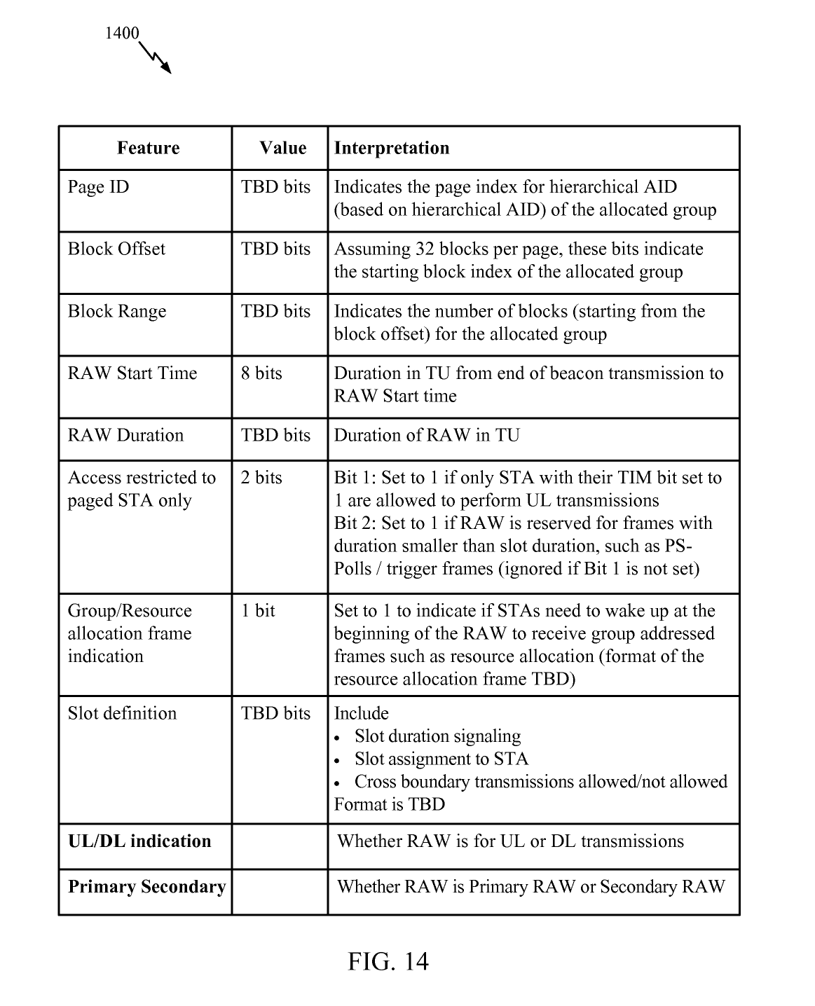

In some cases, a RAW Parameter Set Element IE, such as that illustrated in FIG. 14, may be used to configure hierarchical RAWs. As indicated, this IE may include an UL/DL indication 1402 and a Primary/Secondary indication 1404 (e.g., indicating whether the IE is for a Primary RAW or a Secondary RAW).

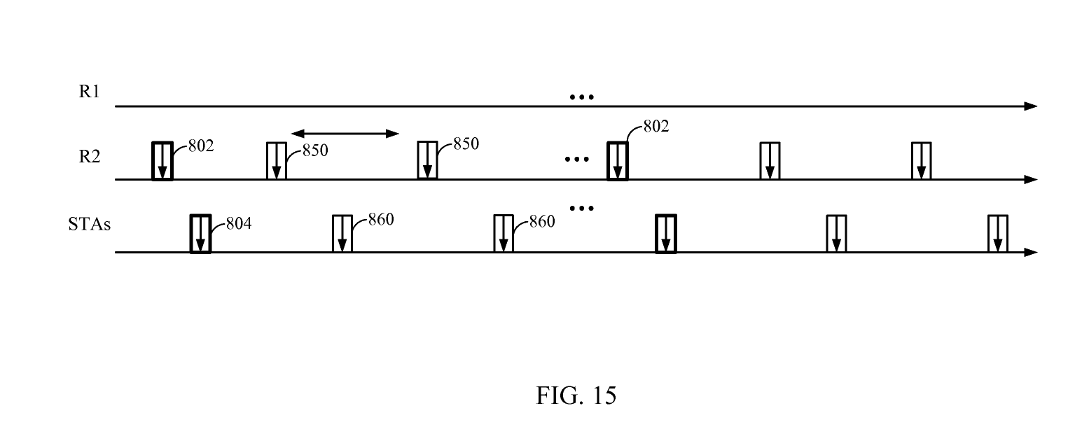

FIG. 15 illustrates an example timing diagram with preferred TFTs for DL data deliver. In this example, a relay R2 and STA are awake at the (Preferred) TWTs 802 and 804. According to a first option (TWT option 1), a device (AP/STA) expects a PS-Poll before delivering data at secondary TWTs 850 and 860. This option may be useful if the STA wants to be in control of its awake cycle (no need for Preferred TWTs) and may be useful if the STA wants to be in control of how much data to receive (e.g., Only 1 MPDU per PS-Poll or Only a max number of MPDUS per Trigger frame). The AP may need to be awake at each TWT where a PS-Poll could be received. According to the second option (TWT option 2), the AP may send data at secondary TWTs 850 and 860 without waiting for a PS-Poll. This approach may have less overhead, but the STA may need to be awake at each TWT 850 and 860 where there could be data. As an alternative, an AP could first send a short data frame (e.g., a null data packet NDP) with a more date bit set (MD=1) just to test if a STA is awake. The AP can sleep whenever it does not have data to send.

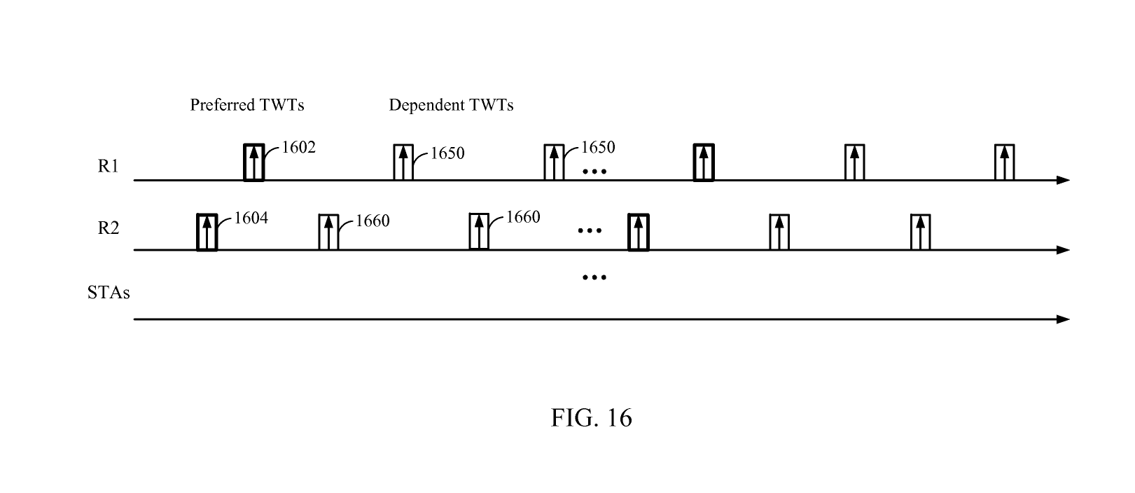

FIG. 16 illustrates a similar timing diagram with preferred UL TWTs. In this case, the AP may be awake at the Preferred (Primary) TWT 1602/1604. If no data/NDP/PS-Poll with an uplink data indicator (UDI) is received indicating that data is available, then the AP goes to sleep, ignoring dependent (Secondary) TWTs 1650/1660. If there is an indication that data is available is received, the AP stays awake until a packet is received indicating that there is no other data (or a timer expires with no data received). In some cases, a reverse PS-Poll may be used, for example, with some mechanism for a receiver to limit the number of packets received. If an AP uses a PS-Poll, the STA may need to be awake at the Preferred TWT 1602/1604 and should be awake at dependent TWTs 1650/1660 if the AP sent a PS-Poll at the preferred TWT and STA indicated More Data.

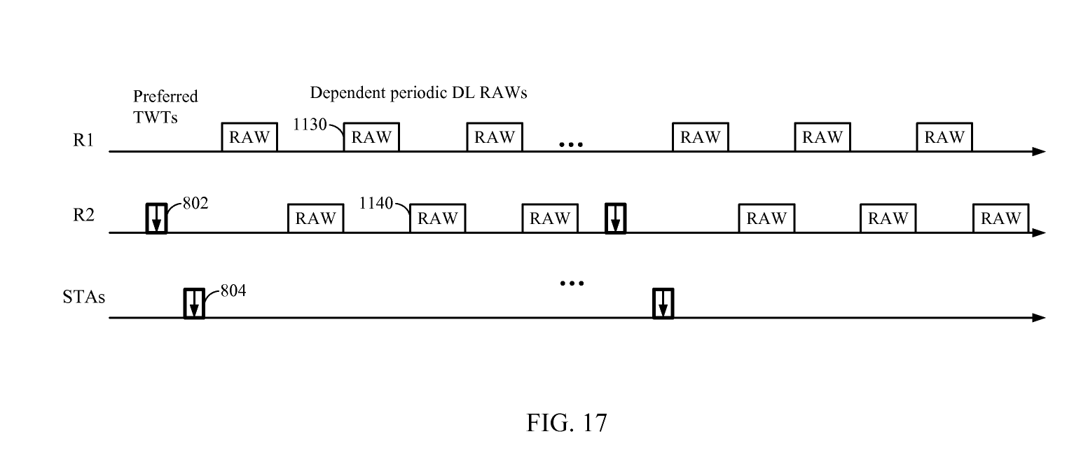

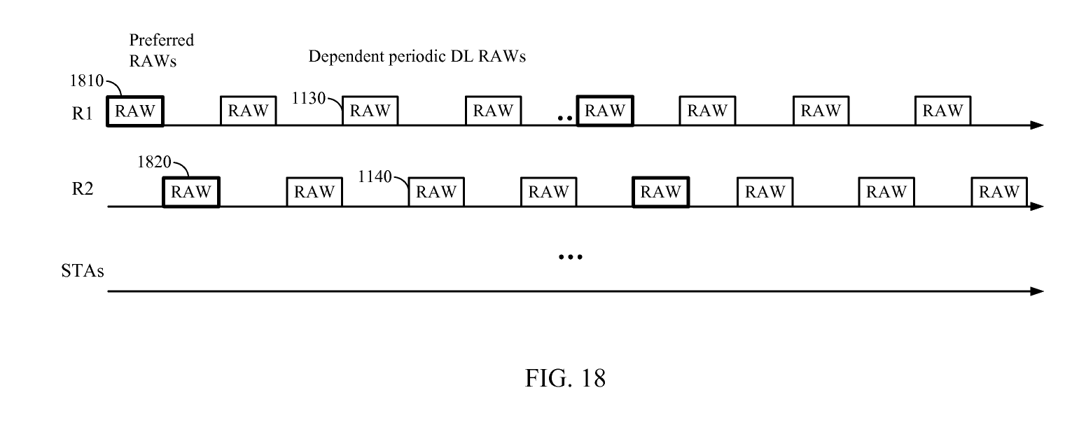

FIG. 17 illustrates example timing for DL data using a combination of TWTs and RAWs. In this example, if no data/NDP is received or the ACK to PS-Poll indicates no data at a primary TWT 802/804, a STA goes back to sleep and tries again at the next primary TWT. An AP may indicate data available for multiple STAs. A dependent RAW (1130/1140) may be in place and STAs may be allowed to contend only in the assigned RAW to send Ps-Poll (e.g., RAW for paged STAs+sleep indication) and STAs may expect DL traffic only in the assigned RAW (RAW for DL+sleep indication). According to certain aspects, an AP can sleep in a DL RAW if it did not indicate to STAs (during TWT 802/804) that there is data. FIG. 18 illustrates a similar example as FIG. 17, but using preferred/primary RAWs 1810/1820 instead of preferred/primary TFTs 802/804.

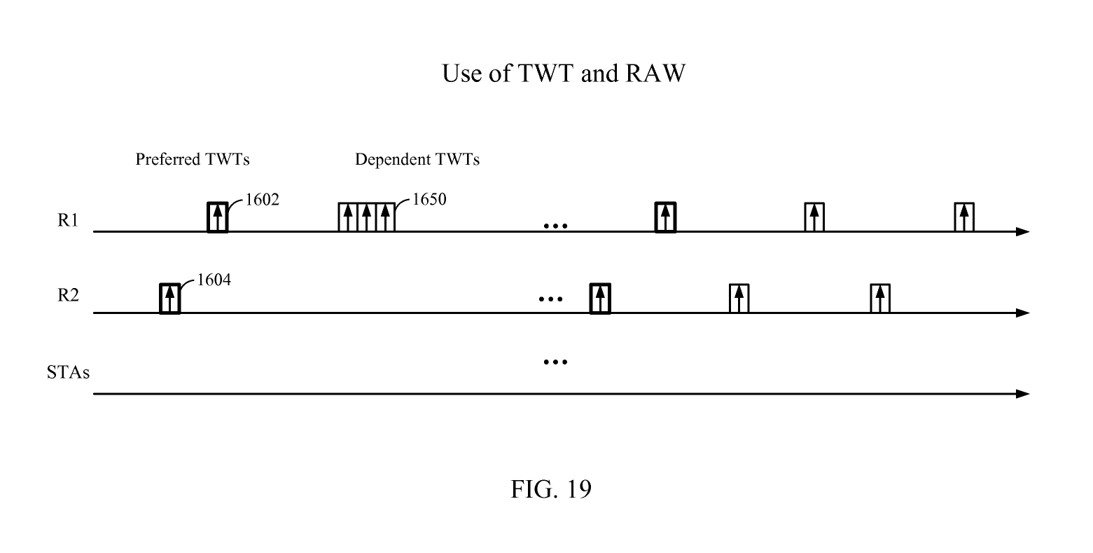

FIG. 19 illustrates another example timing of UL Use of TWTs. As illustrated, the AP may be awake Uplink at the Preferred TWT 1602/1604. If no data/NDP/PS-Poll with UDI is received indicating that data is available, then the AP may goes to sleep. On the other hand, if an indication that data is available is received, the AP may stay awake for a bundle of dependent TWTs, for example, until a packet is received indicating that there is no other data. As an alternative, an AP may stay awake for a period of time (e.g., until a timer expires) with no data received. In some cases, a reverse PS-Poll may be used, for example, but with some mechanism for a receiver to limit a number of packet received. If an AP uses PS-Poll, a STA may be awake at the Preferred TWT 1602/1604 and should also be awake at dependent TWTs 1650 if the AP sent a PS-Poll at the preferred TWT and the STA indicated More Data (MD=1).

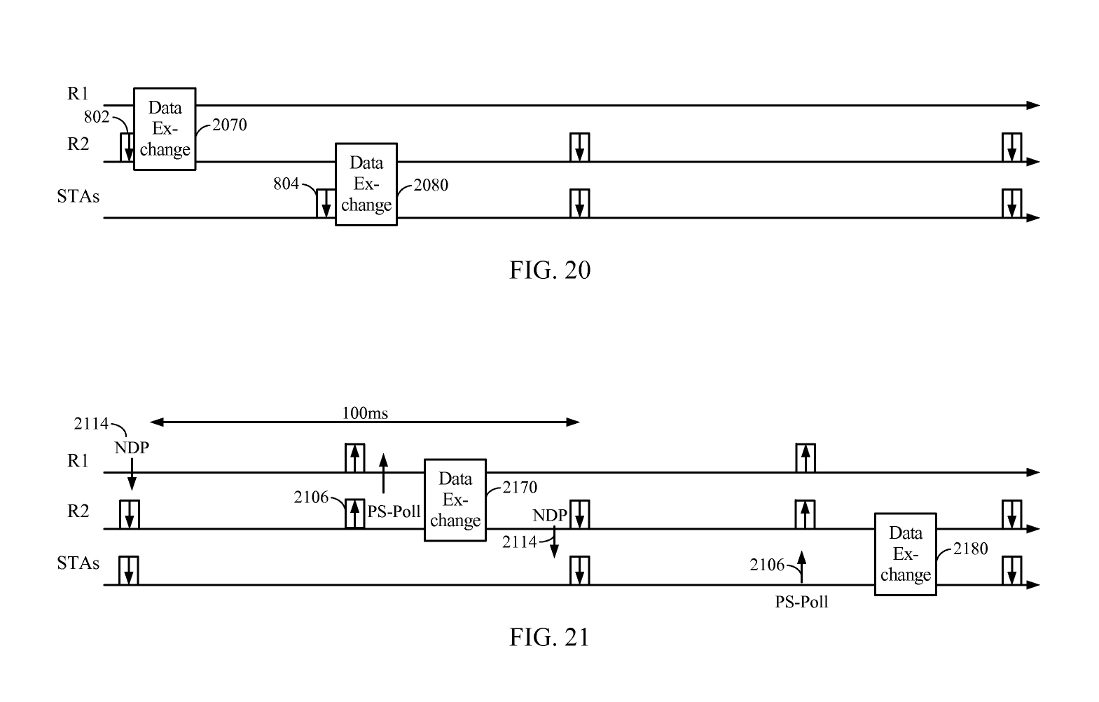

FIG. 20 illustrates an example use of hierarchical TWTs for DL data delivery. As shown, the presence of data may be signaled in a primary TWT 802, triggering relay R2 to stay awake for a data exchange 2070 with relay R1. In turn, relay R2 may signal the presence of data (to STAs) in a primary TWT 804, triggering STAs to stay awake for a data exchange 2080 with relay R2.

FIG. 21 shows another example use of hierarchical TWTs for DL data delivery, but with PS-Polls sent by receiving stations. In the illustrated example, an AP (relay R1) indicates the presence of data via NDP 2114. In a subsequent TWT, relay R2 sends a PS-Poll, triggering a data exchange 2170 with R1 (receiving the DL data from R1). In turn, relay R2 may signal the presence of data (to STAs) via NDP 2114, causing STAs to send a PS-Poll in a subsequent TWT, triggering a data exchange 2180 with STAs (receiving the DL data from R2).

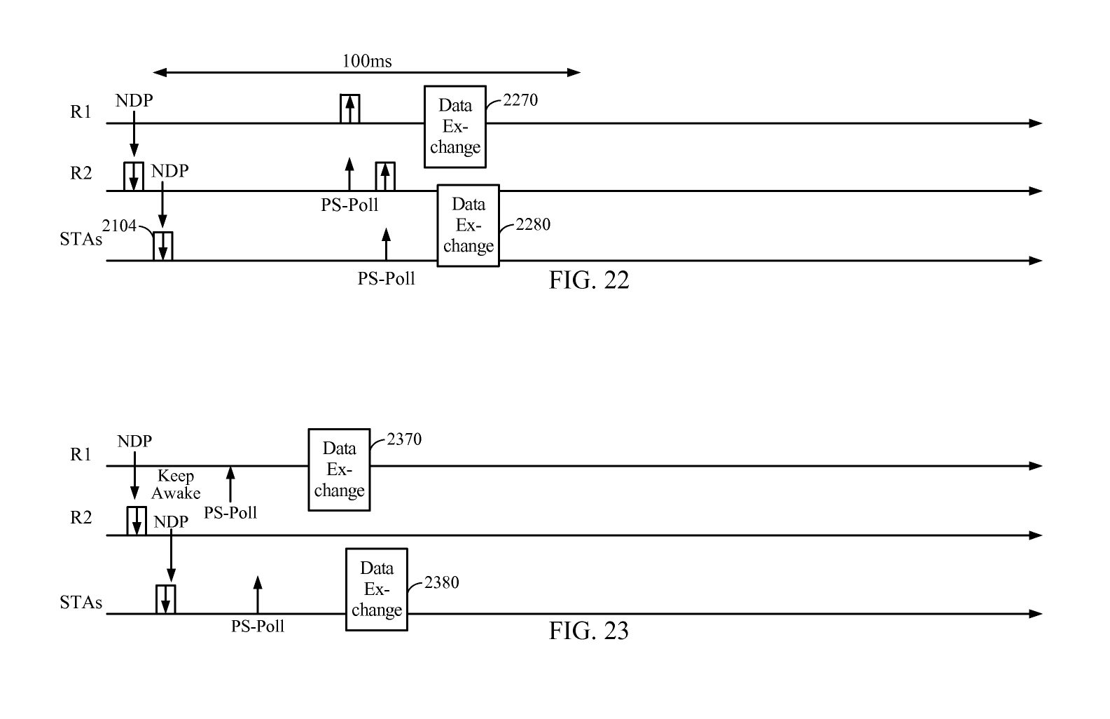

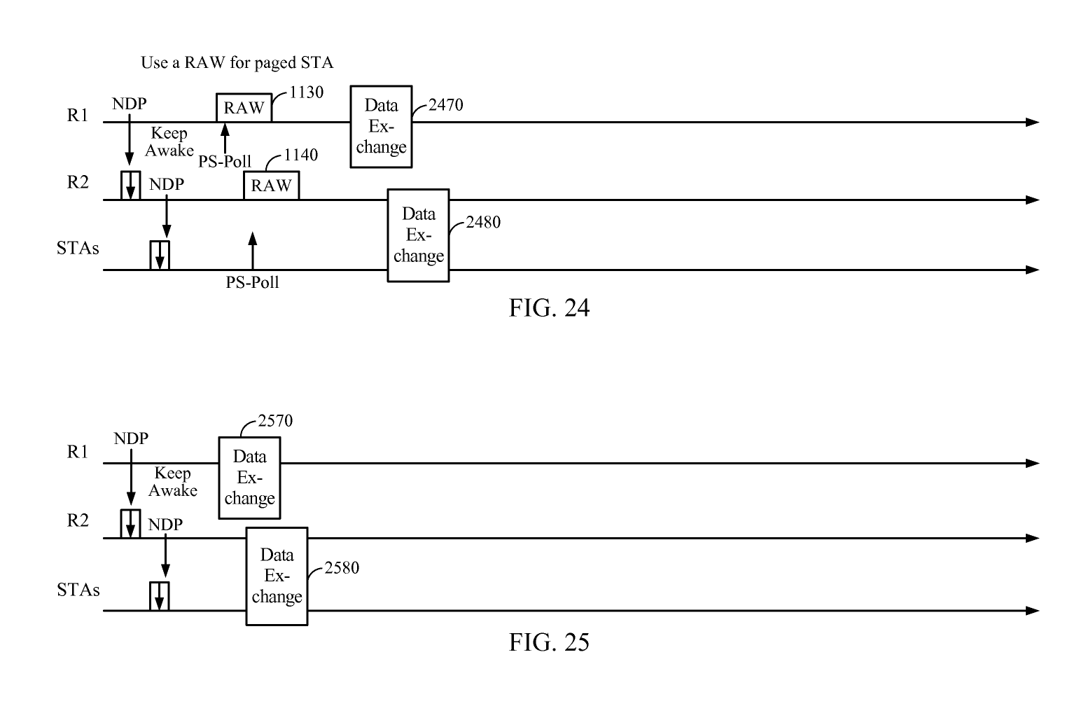

As illustrated in FIG. 22, optimizations may be made for DL data delivery. For example, with staggered TWTs, R2 and STA may be able to send PS-Polls (to R1 and R2, respectively), allowing data exchange 2280 between R2 and STAs to begin as soon R2 receives data from R1 via data exchange 2270. In another example shown in FIG. 23, after receiving NDPs indicating the presence of DL data, R2 and STAs may not even wait for a subsequent TWT before sending PS-Polls, thus triggering data exchanges 2370 and 2380 even sooner (than shown in FIG. 22). As shown in FIG. 24, in some cases, staggered RAWs 1130 and 1140 may be configured to allow R2 and STAs to send PS-Polls, triggering data exchanges 2470 and 2480. FIG. 25 shows yet another example use of hierarchical TWTs for DL data delivery, but without PS-Polls. In this example, R1 and R2 may send DL data (at 2570 and 2580, respectively) automatically after sending NDPs indicating its presence, without waiting for PS-Polls.

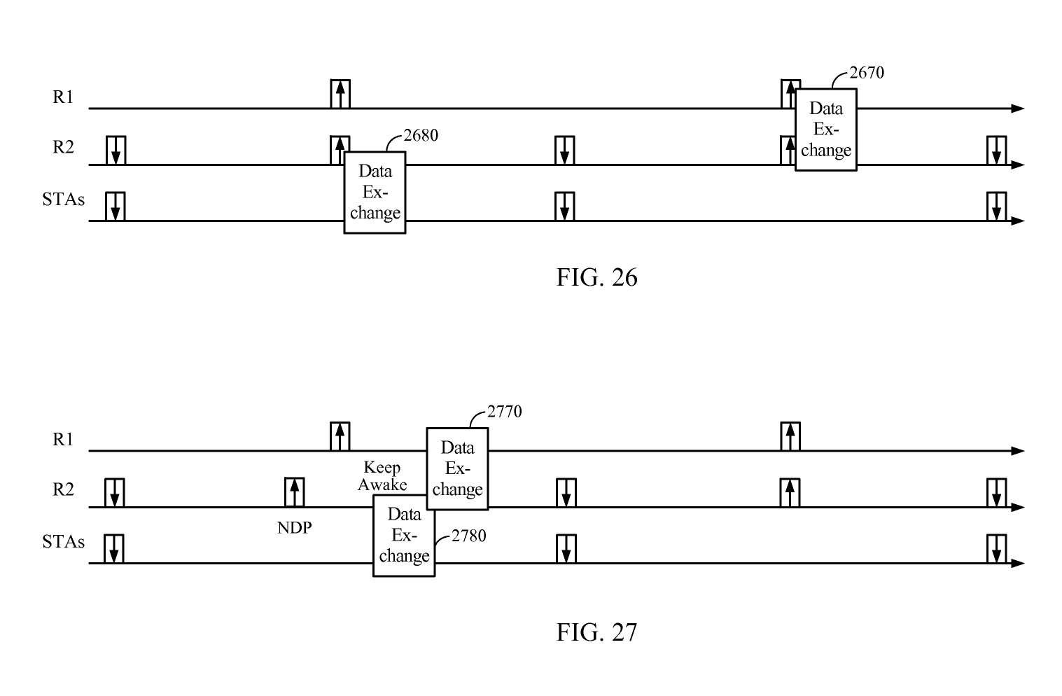

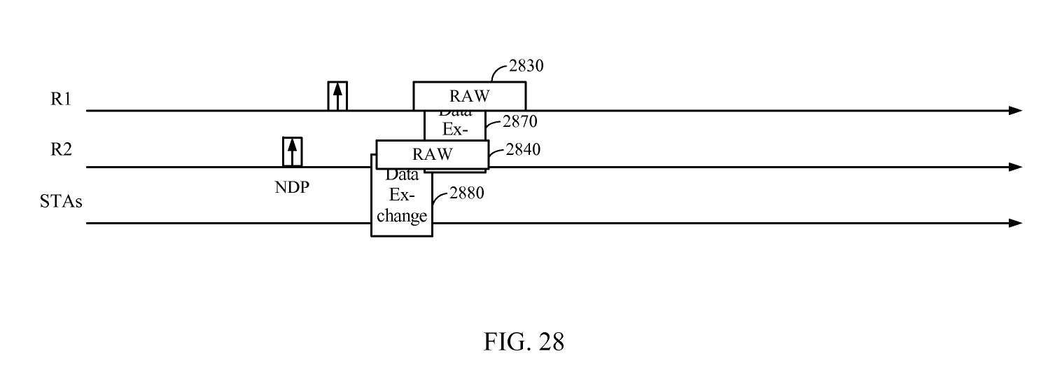

FIG. 26 illustrates an example use of hierarchical TWTs for UL data delivery. As shown, with aligned UL TWTs, STAs may signal the presence of and send UL data to R2 via data exchange 2680. In turn, in a subsequent UL TWT, relay R2 may signal the presence of and send UL data to R2 via data exchange 2670. As shown in FIG. 27, STAs may signal the presence of UL data to R2 via a short frame (e.g., NDP) indication more data, with R2 propagating the NDP to R1. As illustrated, the UL data may be sent, via data exchanges 2780 and 2770, without waiting for a subsequent UL TWT. As illustrated in FIG. 28, in some cases, staggered RAWs 2840 and 2830 may be configured to allow for UL data exchanges 2870 and 2880, respectively.

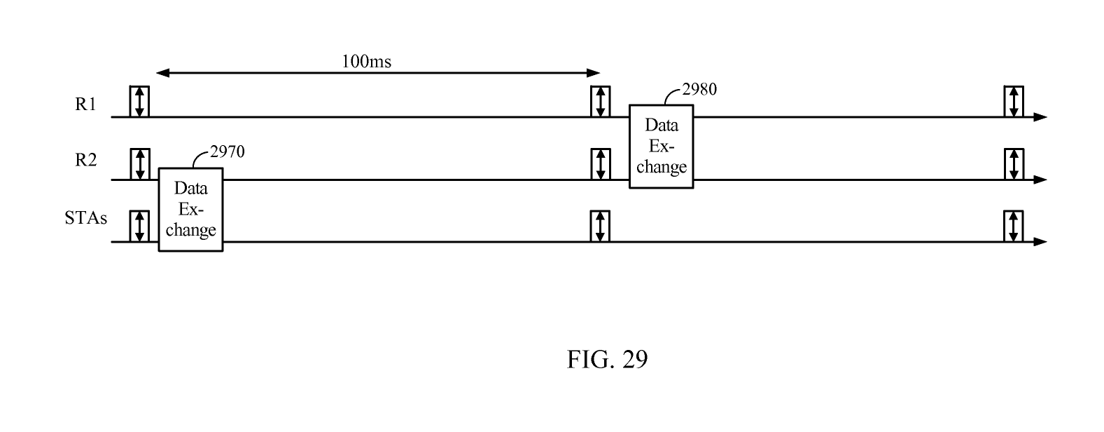

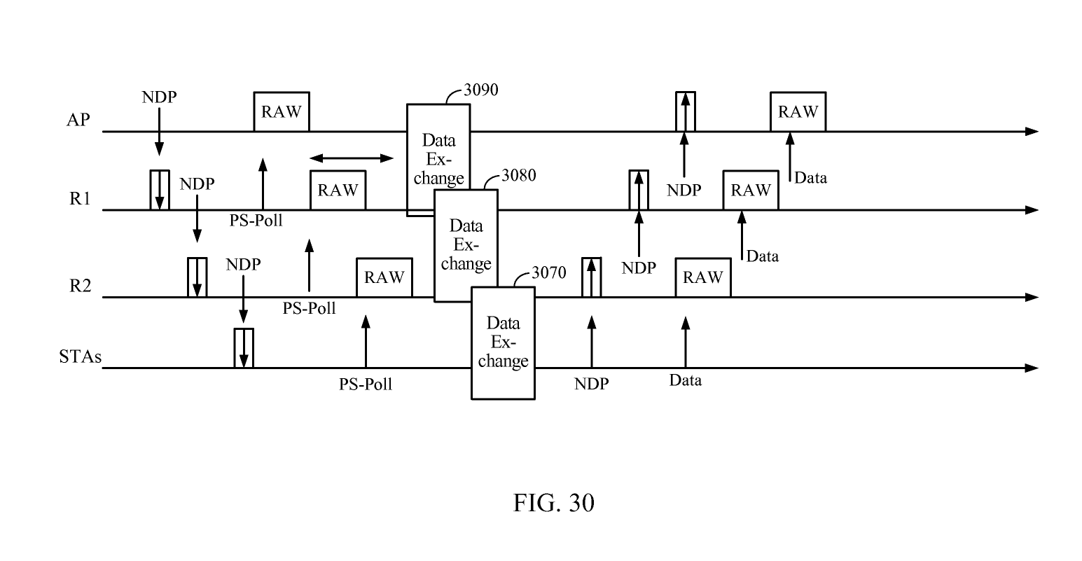

As illustrated in FIG. 29, in some cases, UL/DL data exchanges 2970 and 2980 may be periodically scheduled (e.g., at scheduled transmission times t_{sch}) to coincide with TWTs. FIG. 30 provides a summary of techniques presented herein, utilizing TWTs and RAWs for the exchange of DL and UL data. As illustrated, DL data for STAs from an AP may be signaled via NDPs. Each device at the various hops may send PS-Polls (illustratively during RAWs) prompting the DL data to be sent via a series of data exchanges (3090 from AP to R1, 3080 from R1 to R2, and 3070 from R2 to the STAs). Similarly, the STAs may signal UL data via NDPs sent in UL TWTs, and subsequently send the UL data (illustratively during RAWs).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 and 600 illustrated in FIGS. 5 and 6 correspond to means 500A and 600A illustrated in FIGS. 5A and 6A, respectively.

For example, means for transmitting may comprise a transmitter (e.g., the transmitter unit 222) and/or an antenna(s) 224 of the access point 110 illustrated in FIG. 2 or the transmitter 310 and/or antenna(s) 316 depicted in FIG. 3. Means for receiving may comprise a receiver (e.g., the receiver unit 222) and/or an antenna(s) 224 of the access point 110 illustrated in FIG. 2 or the receiver 312 and/or antenna(s) 316 depicted in FIG. 3. Means for processing, means for determining, means for detecting, means for scanning, means for selecting, or means for terminating operation may comprise a processing system, which may include one or more processors, such as the RX data processor 242, the TX data processor 210, and/or the controller 230 of the access point 110 illustrated in FIG. 2 or the processor 304 and/or the DSP 320 portrayed in FIG. 3.

According to certain aspects, such means may be implemented by processing systems configured to perform the corresponding functions by implementing various algorithms (e.g., in hardware or by executing software instructions) described above for performing fast association. For example, means for identifying wakeup periods may be implemented by a processing system performing an algorithm that identifies wakeup periods based on a configuration (e.g., via an IE), means for determining whether to enable radio functions during wakeup periods may be implemented by a (same or different) processing system performing an algorithm that takes, as input, the wakeup periods and whether the presence of data has been indicated, while means for enabling radio functions may be implemented a (same or different) processing system performing an algorithm that takes, as input, the decision from means for determining and generates signals to enable/disable the radio functions accordingly.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to:
identify a plurality of wakeup periods during which the apparatus may choose to enable radio functions in order to relay data from a first wireless device to a second wireless device;
determine, for at least some of the wakeup periods, whether to enable the radio functions based on one or more conditions; and
enable the radio functions if the one or more conditions indicate there is data to be received or transmitted.

2. The apparatus of claim 1, wherein:
the processing system is configured to determine, for a current wakeup period, whether to enable radio functions based on an indication received during a previous wakeup period.

3. The apparatus of claim 1, wherein:
the processing system is configured to limit an amount of data transferred during each of the wakeup periods.

4. The apparatus of claim 3, wherein the limit is based on at least one of: a maximum allowable number of Bytes, a maximum allowable number of MSDUs, a maximum allowable number of MPDUs, a maximum allowable number of PPDUs, or an allowable amount of time in which the apparatus may enable radio functions for each of the wakeup periods.

5. The apparatus of claim 1, wherein:
the one or more conditions comprise receipt of a beacon or other type message indicating there is data to be received or transmitted.

6. The apparatus of claim 1, wherein:
the plurality of wakeup periods comprise primary wakeup periods and secondary wakeup periods; and
the processing system is configured to determine, for a secondary wakeup period, whether to enable radio functions based on an indication transmitted or received during a primary wakeup period.

7. The apparatus of claim 6, wherein:
the primary and secondary wakeup periods are defined in an information element (IE); and
the IE indicates whether a wakeup period defined by the IE is primary or secondary.

8. The apparatus of claim 1, wherein:
the plurality of wakeup periods comprise primary wakeup periods and secondary wakeup periods; and
the processing system is configured to determine an occurrence of at least one secondary wakeup period based on information signaled during a primary wakeup period occurring prior to the at least one secondary wakeup period.

9. The apparatus of claim 8, wherein:
the apparatus is configured to receive a portion of a data burst during the primary wakeup period; and
the processing system is configured to enable radio functions in the at least one secondary wakeup period to receive a remaining portion of the data burst.

10. The apparatus of claim 9, wherein the processing system is configured to determine an occurrence of the remaining portion of the data burst, based on signaling provided during the primary wakeup period or the at least one secondary wakeup period.

11. The apparatus of claim 8, wherein the secondary wakeup periods are indicated by target wakeup time (TWT) periods.

12. The apparatus of claim 8, wherein:
at least one of the secondary wakeup periods is indicated by an explicit TWT period via at least one of a TACK or STACK frame.

13. A method for wireless communications by an apparatus, comprising:
identifying a plurality of wakeup periods during which the apparatus may choose to enable radio functions in order to relay data from a first wireless device to a second wireless device;
determining, for at least some of the wakeup periods, whether to enable the radio functions based on one or more conditions; and
enabling the radio functions if the one or more conditions indicate there is data to be received or transmitted.

14. The method of claim 13, wherein the determining comprises:
determining, for a current wakeup period, whether to enable radio functions based on an indication received during a previous wakeup period.

15. The method of claim 13, further comprising:
limiting an amount of data transferred during each of the wakeup periods.

16. The method of claim 15, wherein the limiting is based on at least one of: a maximum allowable number of Bytes, a maximum allowable number of MSDUs, a maximum allowable number of MPDUs, a maximum allowable number of PPDUs, or an allowable amount of time in which the apparatus may enable radio functions for each of the wakeup periods.

17. The method of claim 13, wherein:
the one or more conditions comprise receipt of a beacon or other type message indicating there is data to be received or transmitted.

18. The method of claim 13, wherein:
the plurality of wakeup periods comprise primary wakeup periods and secondary wakeup periods; and
the determining comprises determining, for a secondary wakeup period, whether to enable radio functions based on an indication transmitted or received during a primary wakeup period.

19. The method of claim 18, further comprising:
receiving only a portion of a data burst during the primary wakeup period; and
the enabling comprises enabling radio functions in the at least one secondary wakeup period to receive a remaining portion of the data burst.

20. An apparatus for wireless communications, comprising:
means for identifying a plurality of wakeup periods during which the apparatus may choose to enable radio functions in order to relay data from a first wireless device to a second wireless device;
means for determining, for at least some of the wakeup periods, whether to enable the radio functions based on one or more conditions; and
means for enabling the radio functions if the one or more conditions indicate there is data to be received or transmitted.
